(19) United States
(12) Patent Application Publication
(10) Pub. No.: US 2025/0266647 A1
(43) Pub. Date: Aug. 21, 2025

(54) ELECTRICAL CONNECTOR WITH IMPROVED GROUNDING STRUCTURE

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: HAOZHE ZI, Irvine, CA (US); JESSE LI, Anaheim, CA (US); TERRANCE F. LITTLE, Fullerton, CA (US); AN-JEN YANG, Irvine, CA (US)

(21) Appl. No.: 19/057,591

(22) Filed: Feb. 19, 2025

Related U.S. Application Data
(60) Provisional application No. 63/555,659, filed on Feb. 20, 2024.

(51) Int. Cl. H01R 13/6581; H01R 12/71; H01R 13/6474

(52) U.S. Cl. CPC H01R 13/6581; H01R 12/716; H01R 13/6474

(57) ABSTRACT

An electrical connector assembly includes: a plug connector including: a row of contacts, a ground lead-frame, and an insulator retaining the row of contacts and the ground lead-frame, the ground lead-frame having plural ground contacts interposed among and aligned with the row of contacts; and plural cable wires terminating to the row of contacts and the ground contacts of the ground lead-frame; and a receptacle connector including: an insulative housing having a tongue extending toward one side thereof and a cavity opening to an opposite side thereof; a row of terminals exposing to the tongue, the row of terminals including plural signal terminals and plural ground terminals, the plurality of ground terminals being exposed to the cavity; and a ground bar disposed in the cavity to connect with the plurality of ground terminals, wherein the ground bar has a beam for making an electrical connection to the ground lead-frame.

### CROSS REFERENCE TO RELATED APPLICATIONS

This application claims the benefit of, and priority to, U.S. Provisional Patent Application No. 63/555,659, filed Feb. 20, 2024, the contents of which are incorporated entirely herein by reference.

### BACKGROUND OF THE INVENTION

### 1. Field of the Invention

The present invention relates to an electrical connector with improved grounding structures.

### 2. Description of Related Arts

U.S. Pat. No. 9,692,183 discloses an electrical connector comprising signal contacts, ground contacts, and a ground bus that electrically commons the ground contacts with each other. The ground contacts are arranged in approximately the same plane as the signal contacts. Two or more ground contacts and the ground bus are integrally fabricated as a single, unitary, continuous structure. The signal contacts have jogs that offset the signal contacts from the ground bus.

U.S. Pat. No. 10,944,214 discloses an electrical connector comprising a terminal group having a signal terminal pair, a ground plate configured to provide a ground terminal on each of both sides of the signal terminal pair, a shield plate configured to be connected to the ground plate, and a twin-ax cable having a pair of conductors which extend through the shield plate and connect to the signal terminal pair and a ground portion which electrically connects to at least one of the shield plate and the ground plate.

Therefore, an improved electrical connector is desired.

### SUMMARY OF THE INVENTION

An object of the present invention is to provide an electrical connector with an improved grounding structure.

To achieve the above-mentioned object, an electrical connector assembly comprises: a plug connector including: a row of contacts, a ground lead-frame, and an insulator retaining the row of contacts and the ground lead-frame, the ground lead-frame having a plurality of ground contacts interposed among and aligned with the row of contacts; and a plurality of cable wires terminating to the row of contacts and the ground contacts of the ground lead-frame; and a receptacle connector including: an insulating housing having a tongue extending toward one side thereof and a cavity opening to an opposite side thereof; a row of terminals secured to the insulating housing and exposing to the tongue, the row of terminals including a plurality of signal terminals and a plurality of ground terminals, the plurality of ground terminals being exposed to the cavity; and a ground bar disposed in the cavity to connect with the plurality of ground terminals, wherein the ground bar has a beam for making an electrical connection to the ground lead-frame.

Other advantages and novel features of the invention will become more apparent from the following detailed description of the present embodiment when taken in conjunction with the accompanying drawings.

### BRIEF DESCRIPTION OF DRAWINGS

FIG. 1 is a perspective view of a receptacle connector in accordance with the present invention mounted on a printed circuit board;

FIG. 2 is an exploded view of the receptacle connector in FIG. 1;

FIG. 3 is a further exploded view of a part of the receptacle connector in FIG. 2;

FIG. 4 is a still further exploded view of a part of FIG. 3;

FIG. 5 shows a bottom assembled view of FIG. 3;

FIG. 6 shows a bottom exploded view of FIG. 3;

FIG. 7 is a side view of FIG. 6;

FIG. 8 is a view similar to FIG. 7 but showing a subsequent state;

FIG. 9 is a perspective view of an electrical connector assembly in accordance with the present invention mounted on a printed circuit board, including a varied receptacle connector and a plug connector;

FIG. 10 is an exploded view of the electrical connector assembly;

FIG. 11 is a view similar to FIG. 10 but from another perspective;

FIG. 12 is an exploded view of the varied receptacle connector in FIG. 10;

FIG. 13 is a further exploded view of a part of the varied receptacle connector in

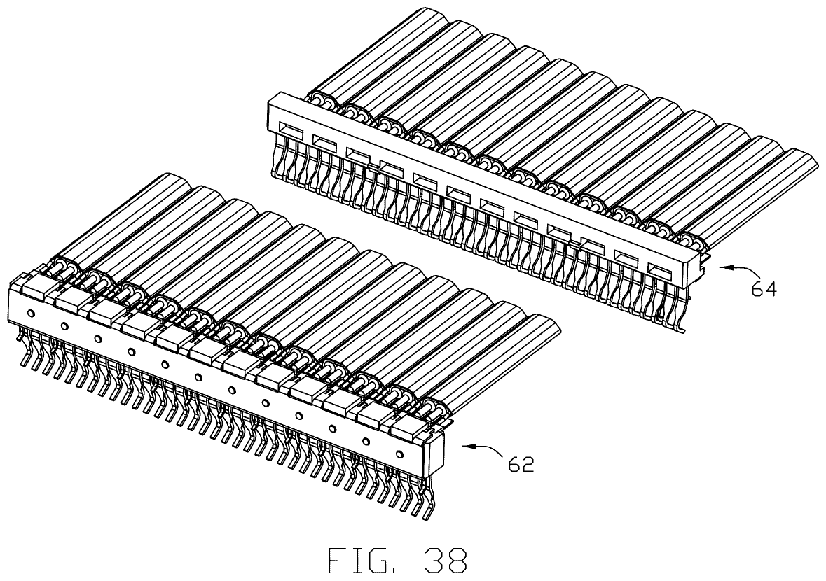

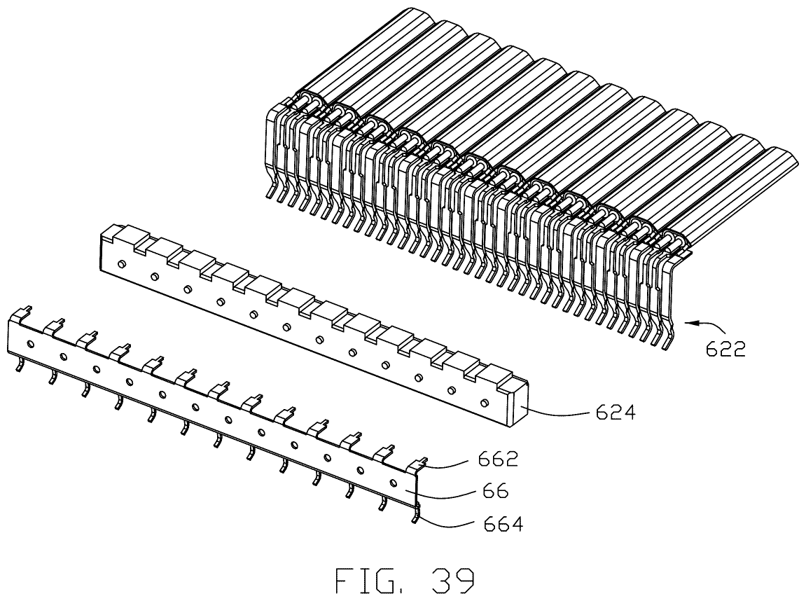

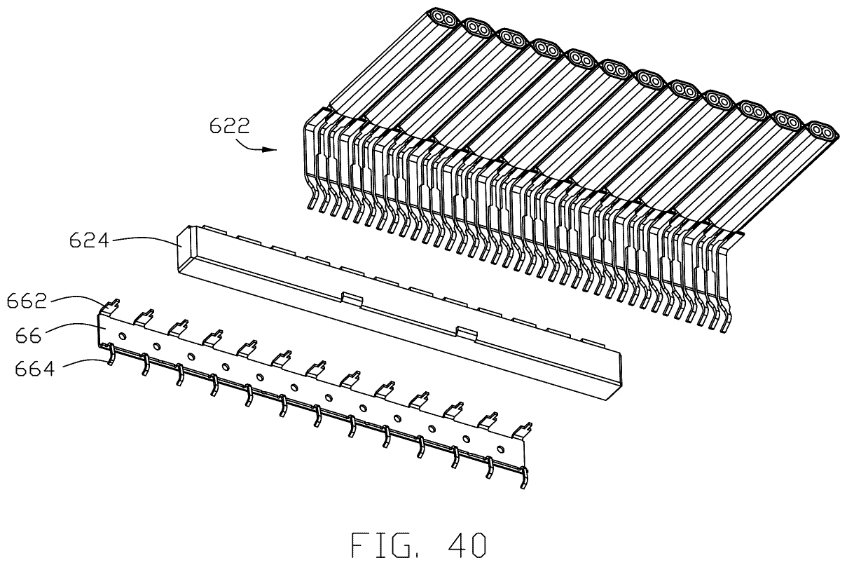

FIG. 12;

FIG. 14 is a still further exploded view of a part of the varied receptacle connector in FIG. 12;

FIG. 15 is a perspective view of a ground bar in FIG. 14;

FIG. 16 is a cross-sectional view of the varied receptacle connector taken along lines A-A in FIG. 12;

FIG. 17 is a cross-sectional view of the varied receptacle connector taken along lines B-B in FIG. 12;

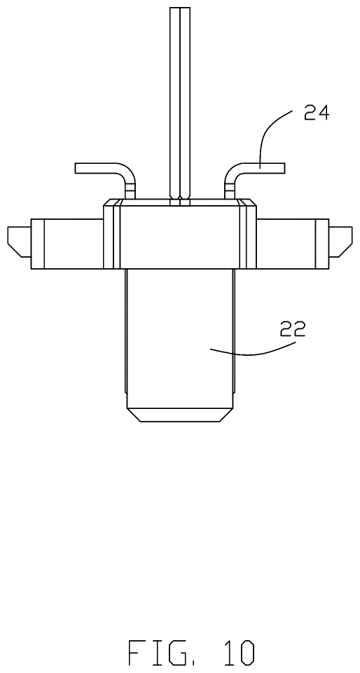

FIG. 18 is an exploded view of a plug connector of the electrical connector assembly in FIG. 10;

FIG. 19 is a view similar to FIG. 18 but from another perspective;

FIG. 20 is a further exploded view of a part of FIG. 19;

FIG. 21 is a view similar to FIG. 20 but from another perspective;

FIG. 22 is a cross-sectional view of the electrical connector assembly taken along lines C-C in FIG. 17;

FIG. 23 is another cross-sectional view of the electrical connector assembly taken along lines C-C in FIG. 17;

FIG. 24 is a perspective view of a varied ground lead-frame of the plug connector in accordance with the present invention;

FIG. 25 is a front view of the varied ground lead-frame;

FIG. 26 is a side view of varied ground lead-frame;

FIG. 27 is an exploded view of FIG. 24;

FIG. 28 is a further exploded view of FIG. 27;

FIG. 29 shows the ground lead-frame in an intermediate state;

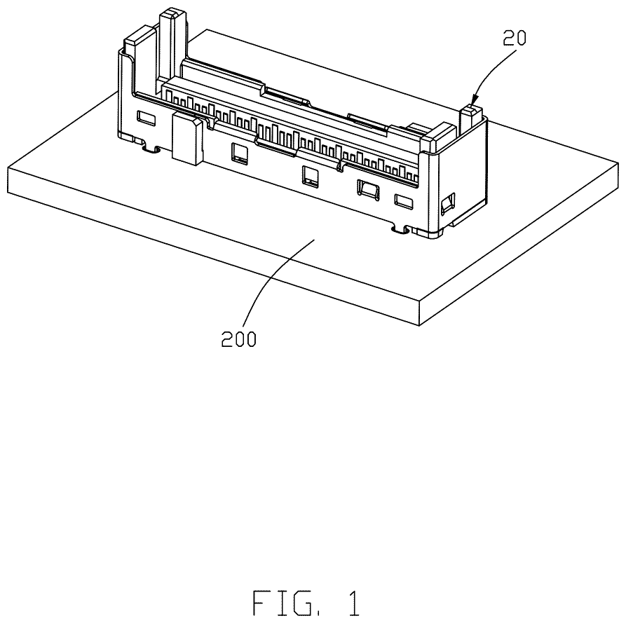

FIG. 30 is a view similar to FIG. 1 but showing a varied ground lead-frame of the plug connector;

FIG. 31 is a front view of FIG. 30;

FIG. 32 is a side view of FIG. 30;

FIG. 33 is a perspective view of a part of a varied plug connector;

FIG. 34 is an exploded view of FIG. 33;

FIG. 35 is a further exploded view of one part of FIG. 34;

FIG. 36 is a view similar to FIG. 35 but from another perspective;

FIG. 37 is a further exploded view of another part of FIG. 34;

FIG. 38 is a view similar to FIG. 37 but from another perspective;

FIG. 39 is a side view of FIG. 33;

FIG. 40 is a top view of the receptacle connector;

FIG. 41 is a cross-sectional side view of FIG. 40;

FIG. 42 is a top view of the varied receptacle connector; and

FIG. 43 is a cross-sectional side view of FIG. 42.

### DETAILED DESCRIPTION OF THE PREFERRED EMBODIMENT

Reference will now be made to the drawing figures to describe the preferred embodiment of the present invention in detail.

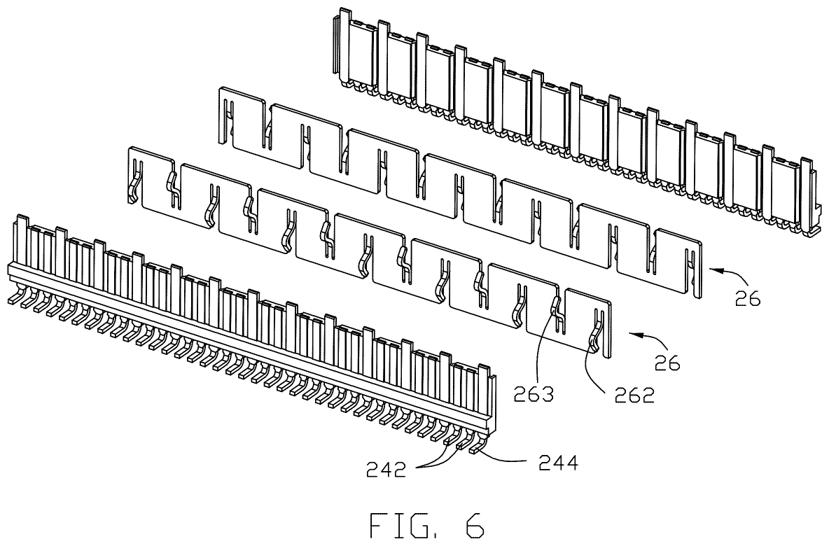

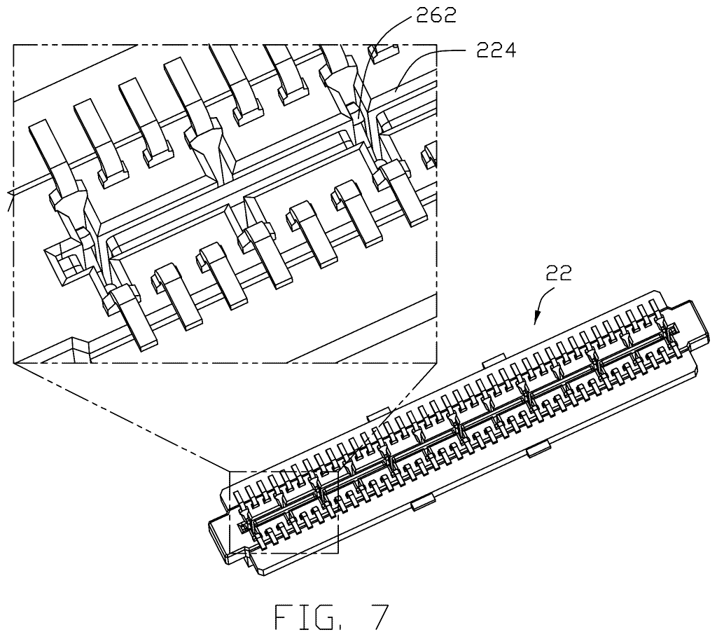

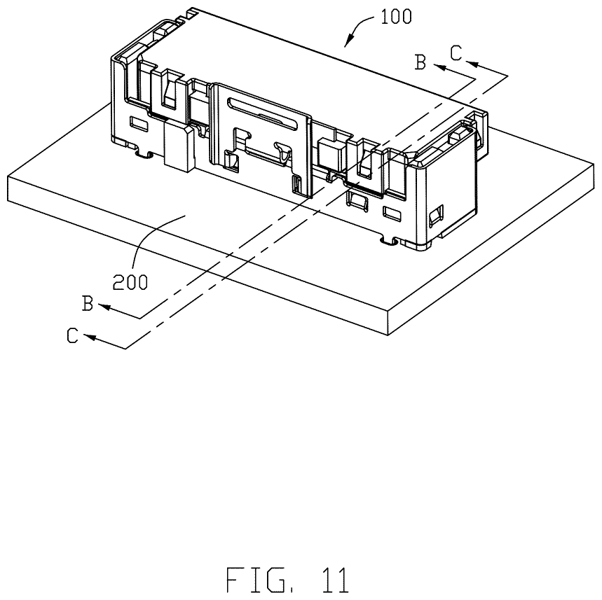

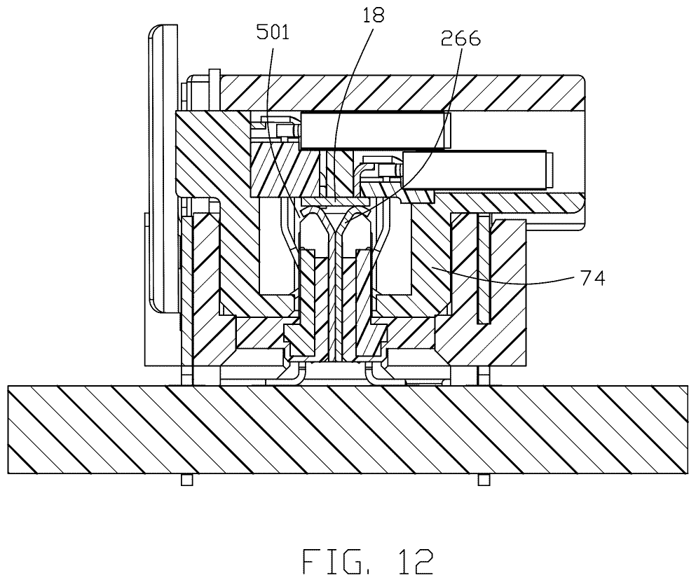

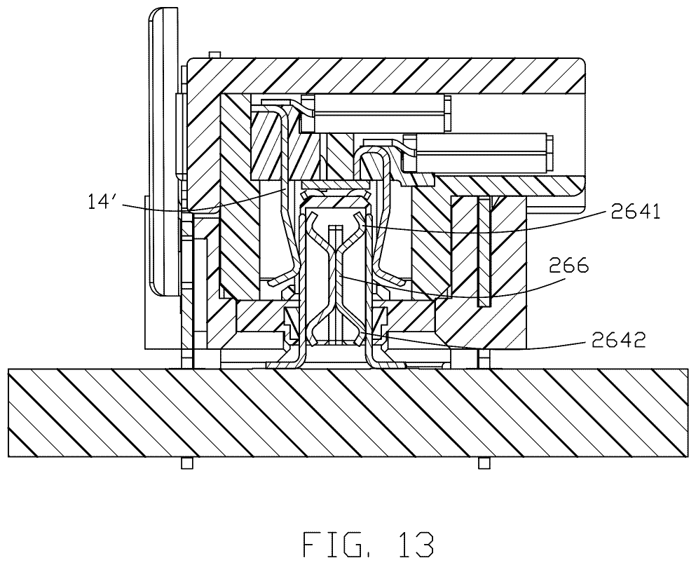

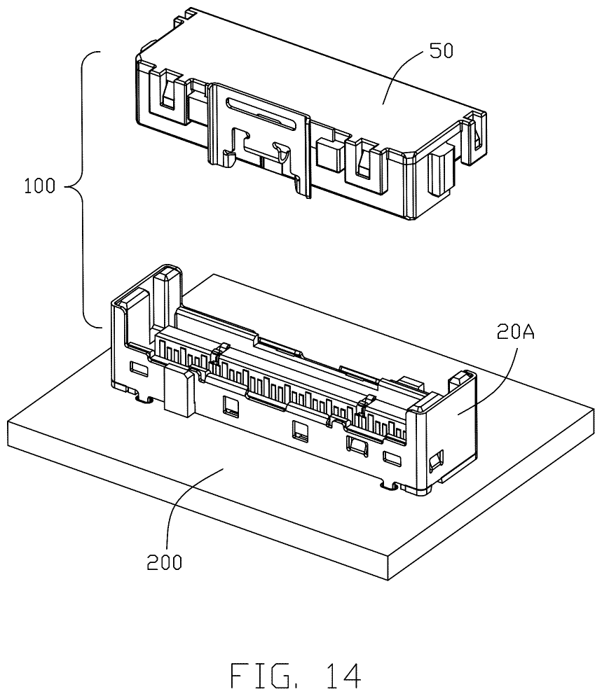

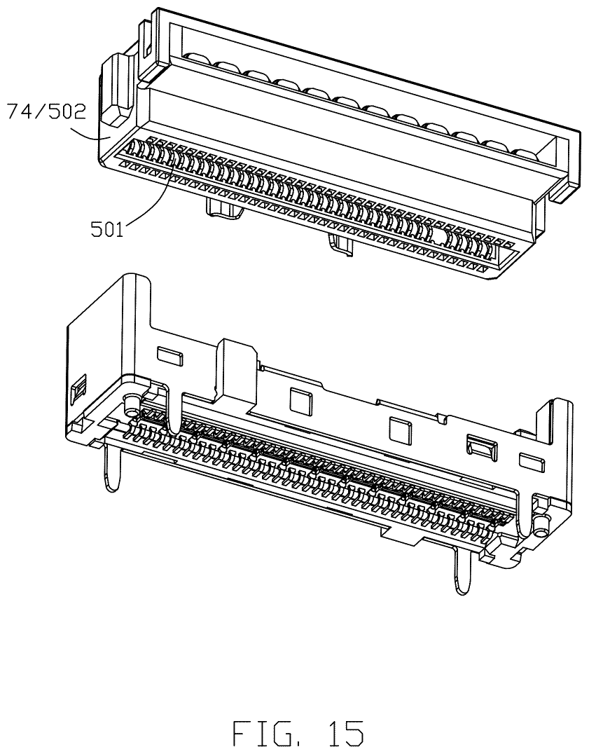

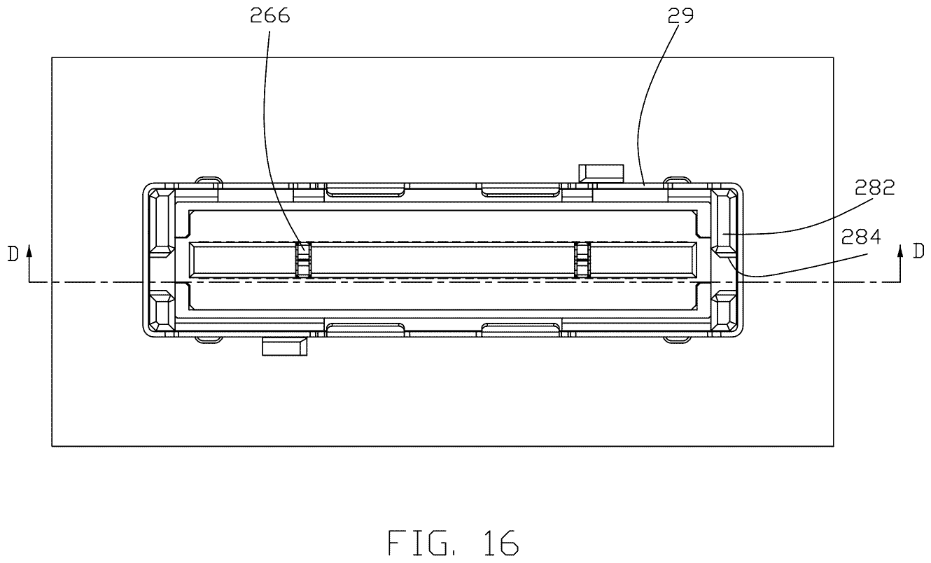

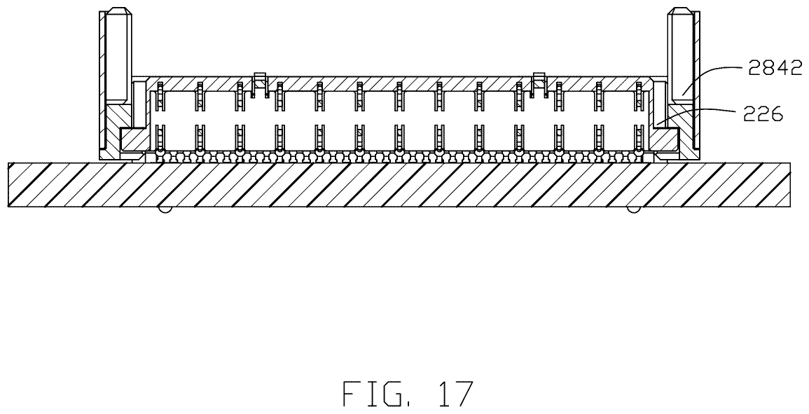

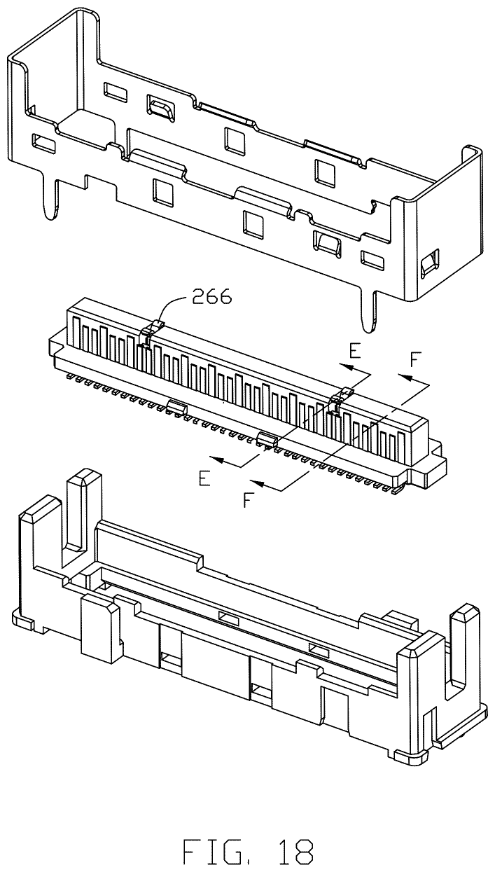

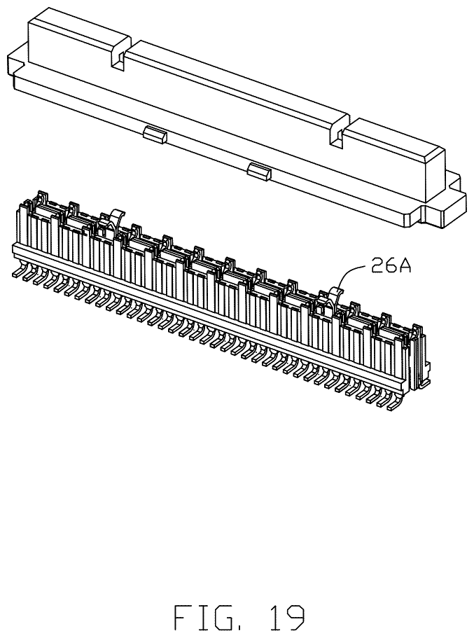

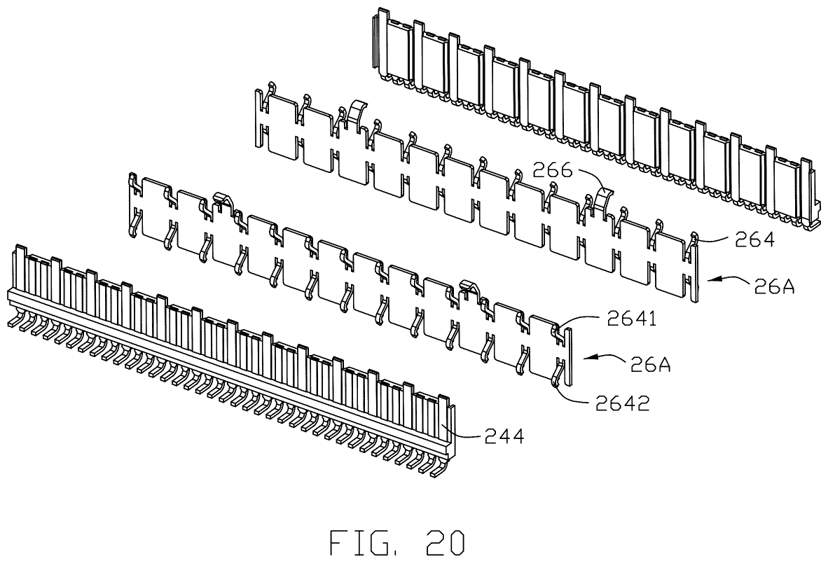

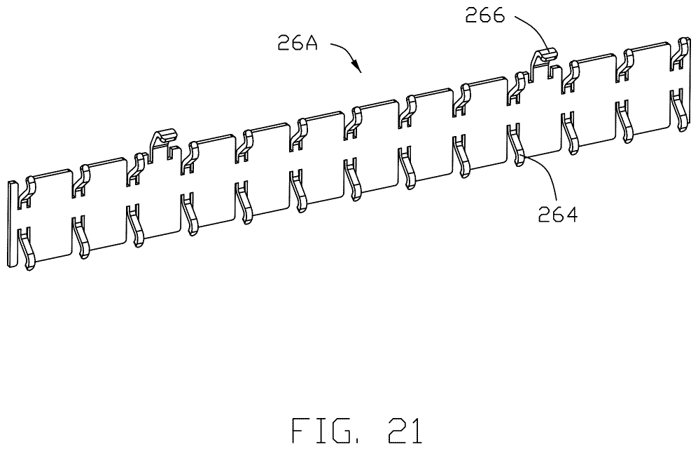

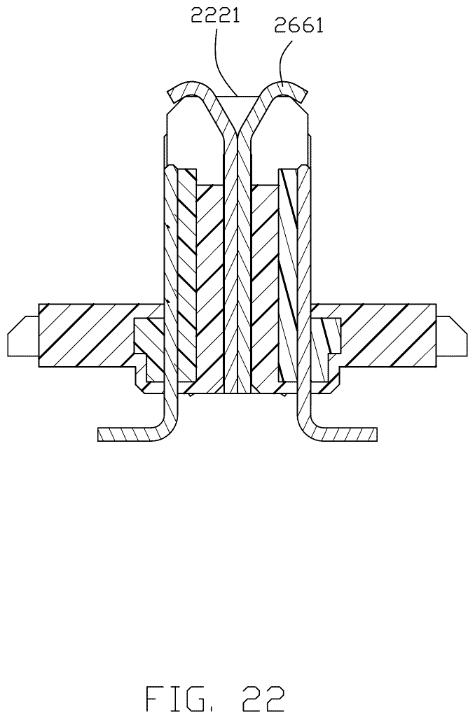

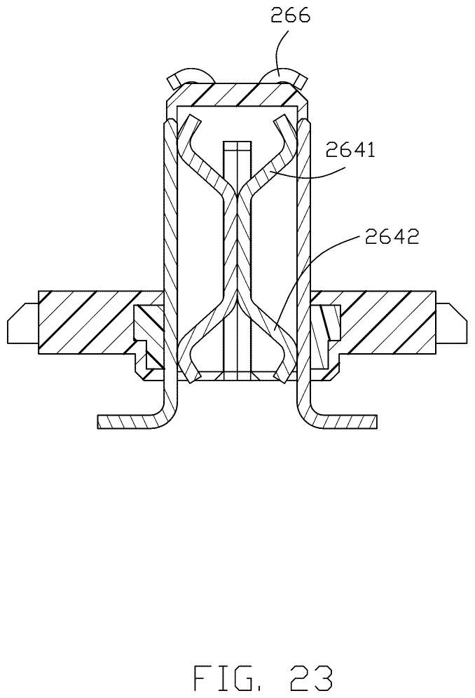

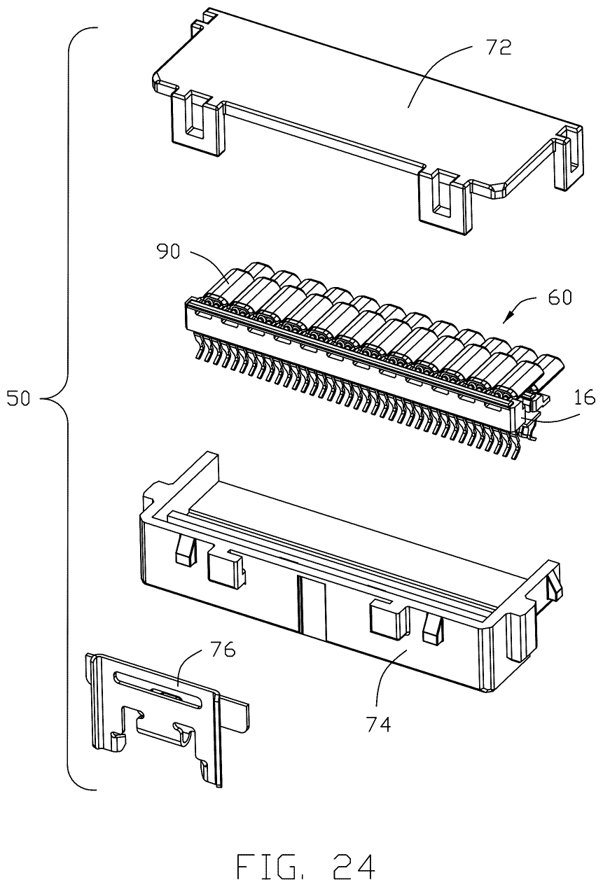

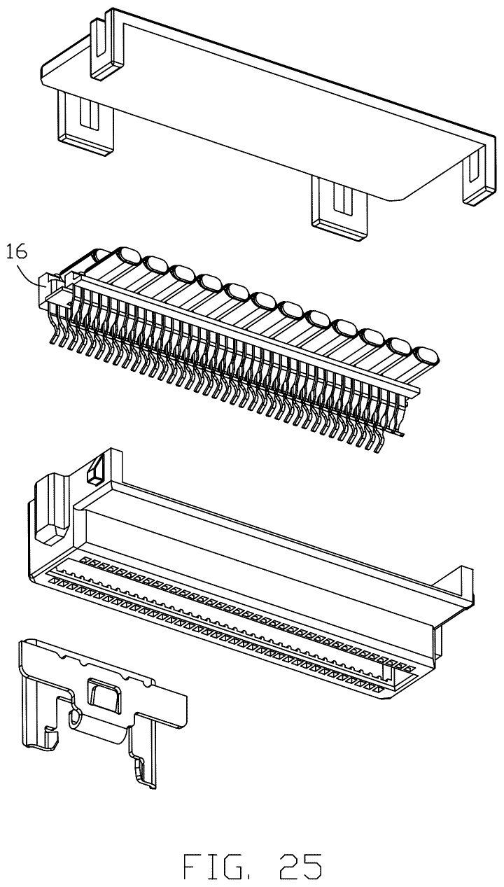

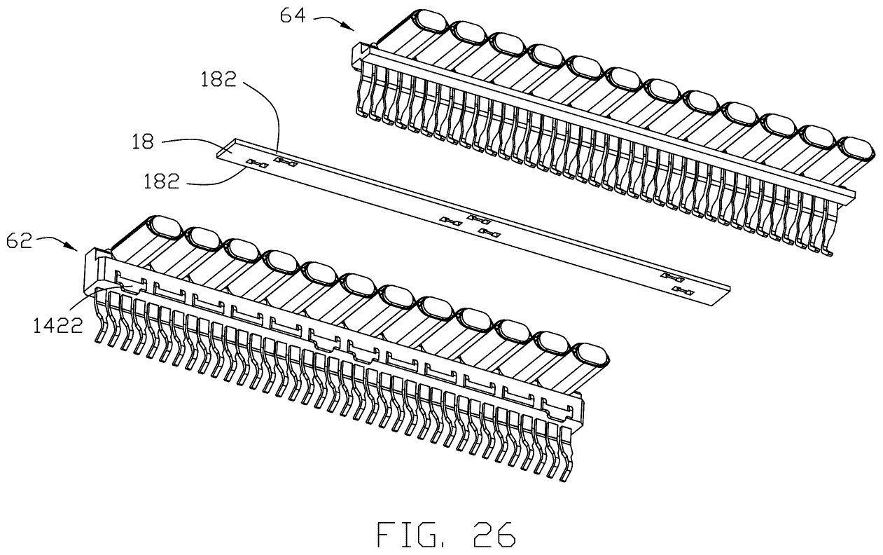

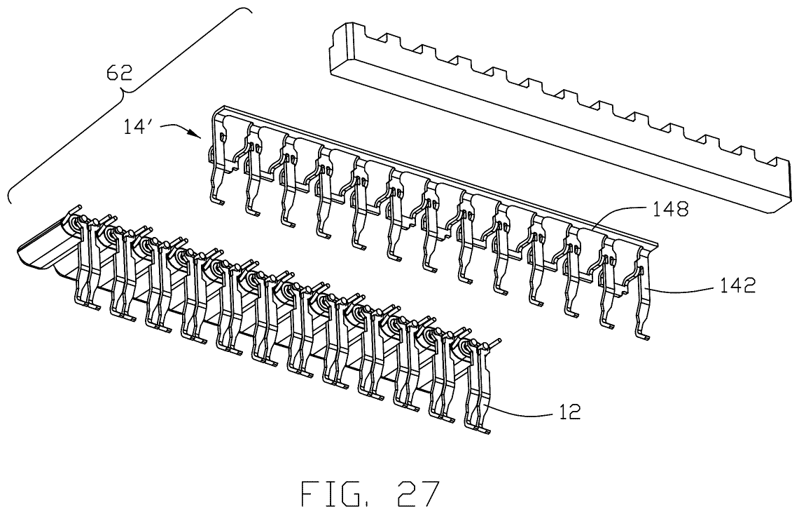

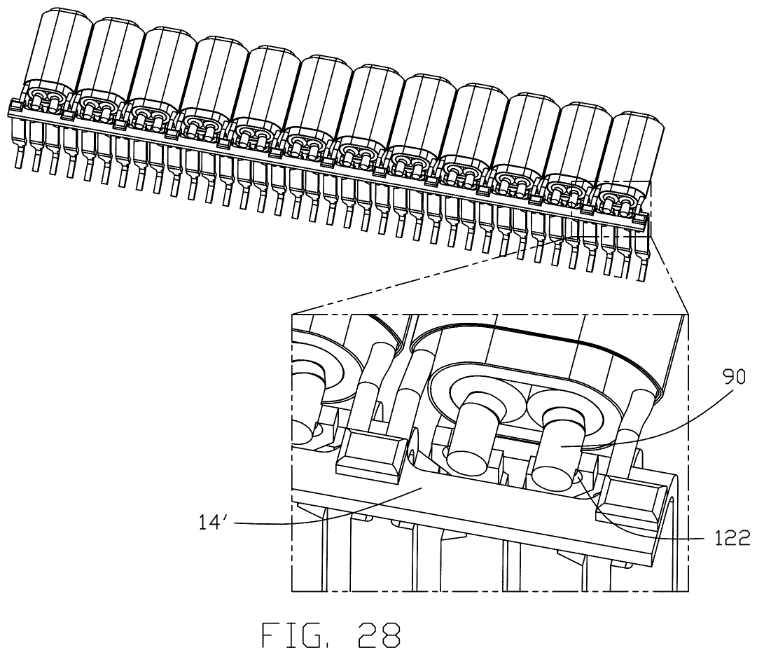

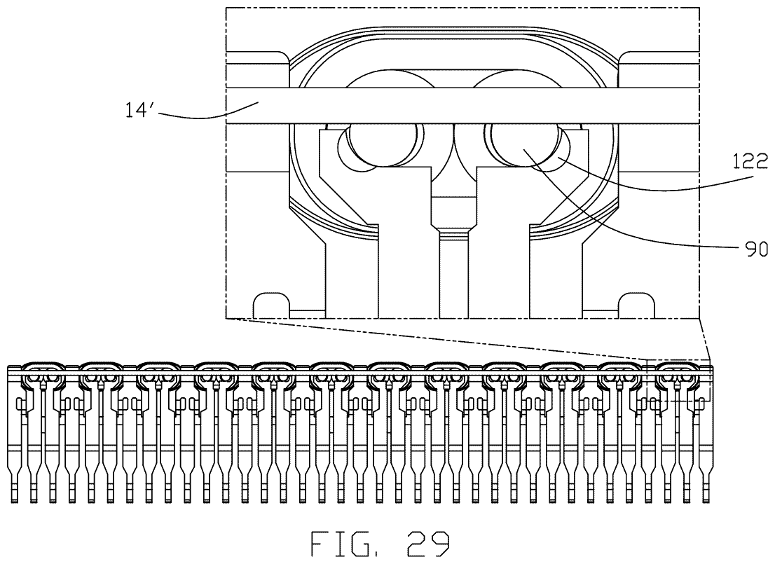

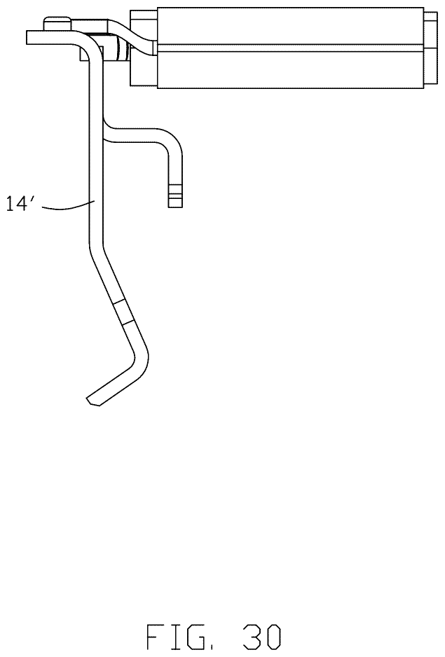

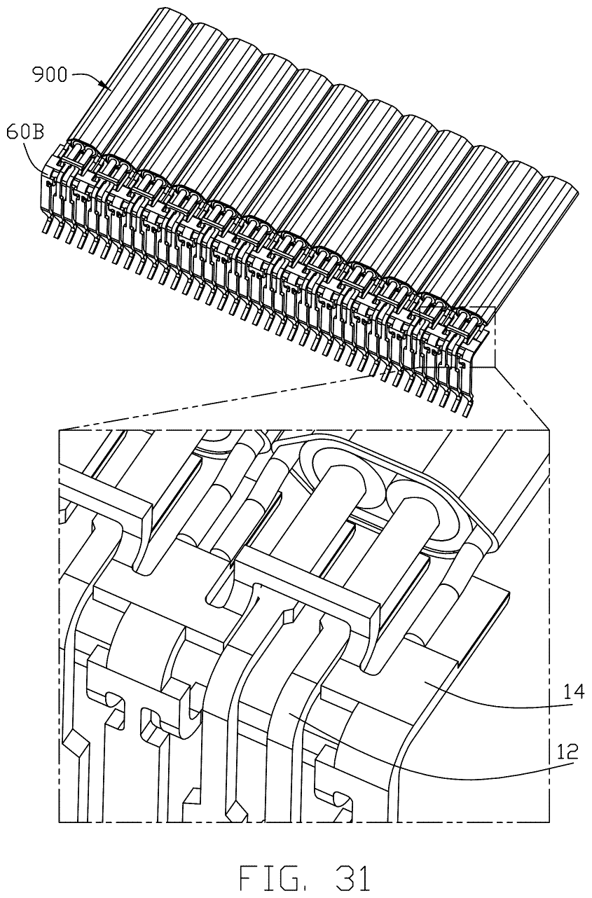

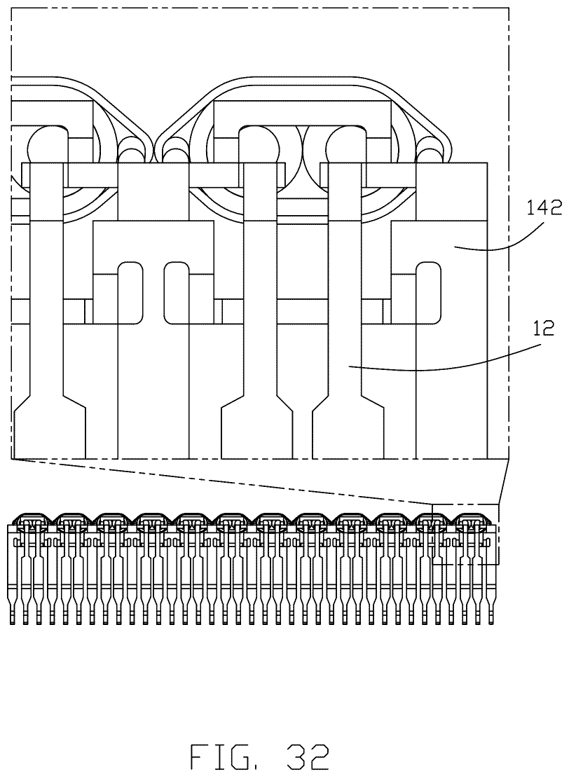

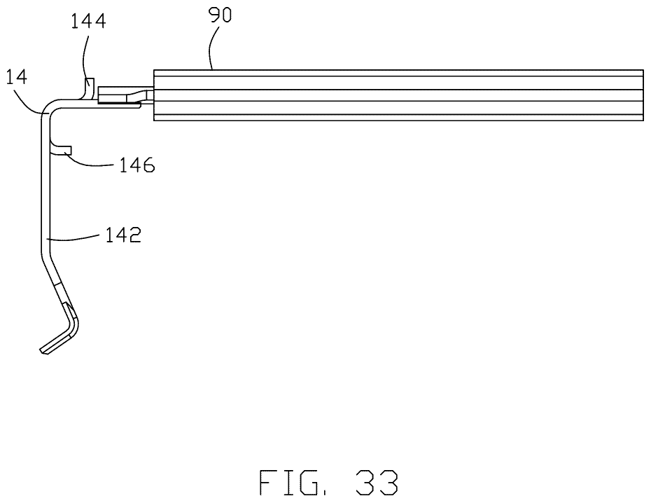

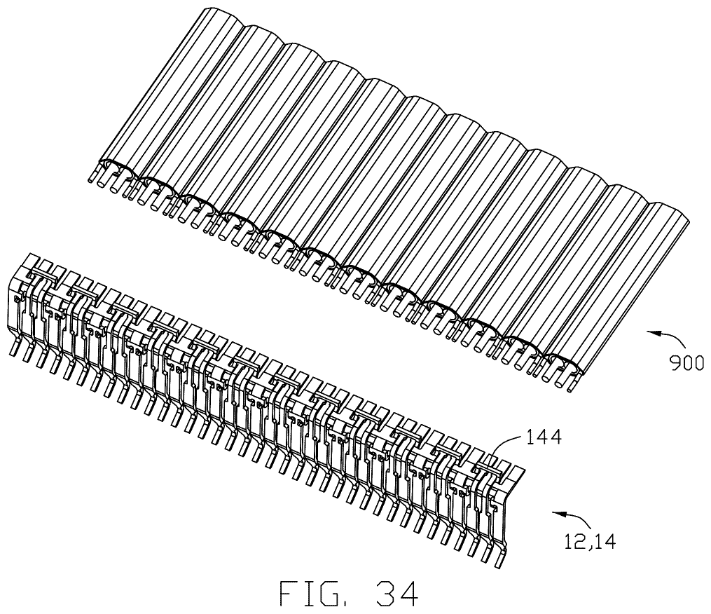

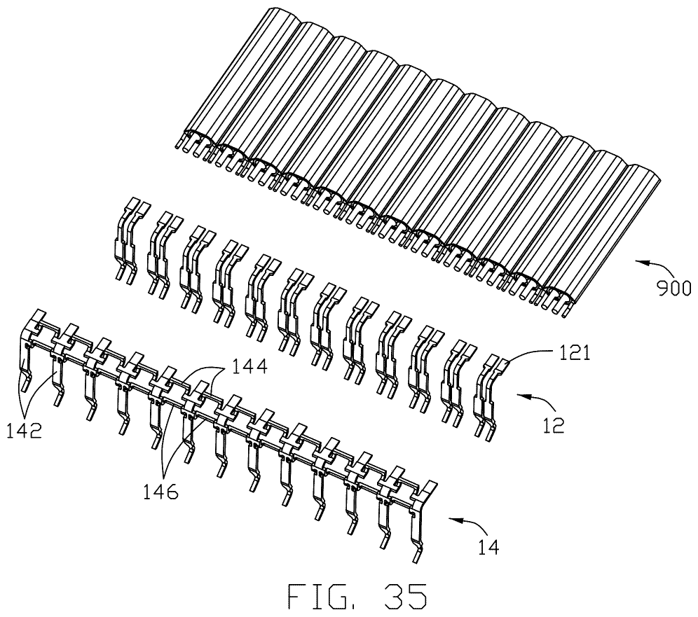

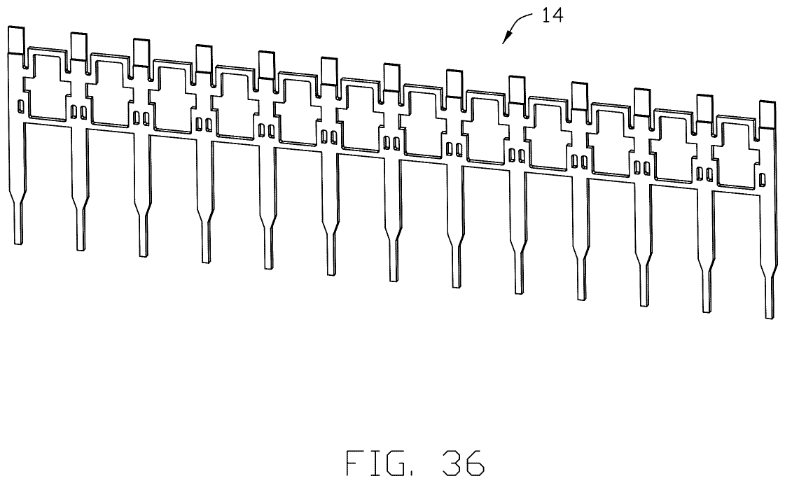

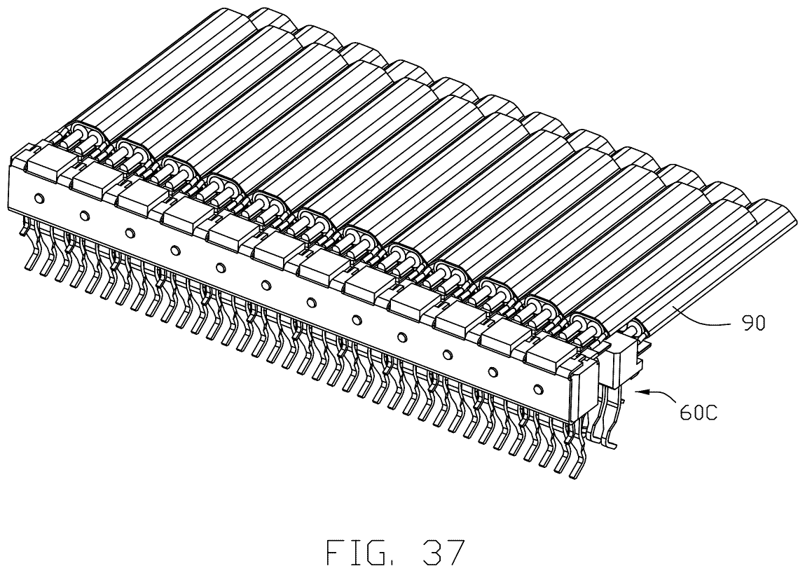

FIGS. 1-8 illustrate a receptacle connector 20 mounted on a circuit board 200, which is adapted for mating with a plug connector 10 as shown in FIGS. 14 and 15. Seen in FIGS. 11, an electrical connector assembly 100 comprises a cable plug connector 10 and a mating receptacle connector 20A mounted on a printed circuit board (PCB) 200.

Referring to FIGS. 1-8, the receptacle connector 20 may include an insulating housing 22, one or more rows of terminals 24, and a ground bar 26. The insulating housing 22 have a tongue 222 extending toward one side thereof and a cavity 224 opening to an opposite side thereof. The rows of terminals 24 are secured to the insulating housing 22 while exposing to the tongue 222. The row of terminals 24 includes a plurality of signal terminals 242 and a plurality of ground terminals 244, the plurality of ground terminals 244 is exposed to the cavity 224. The ground bar 26 is disposed in the cavity 224 and has a plurality of beams 262, 263 or grounding beams to connect with the plurality of ground terminals 244. The receptacle connector 20 may further include a shroud 28 made from insulating material and enclosing the insulating housing 22 and a receptacle shell 29 made from a metal plate and enclosing the shroud 28. The shroud 28 may have features for retaining the insulating housing 22 and the shell 29 may have retention features for retaining to the shroud 28.

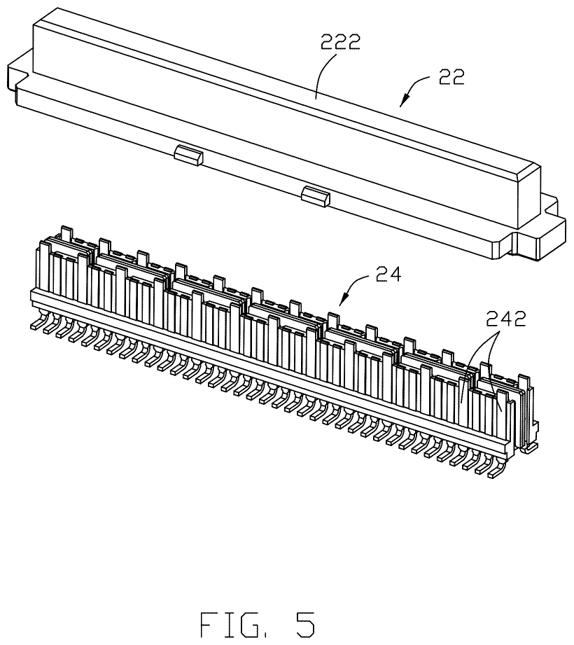

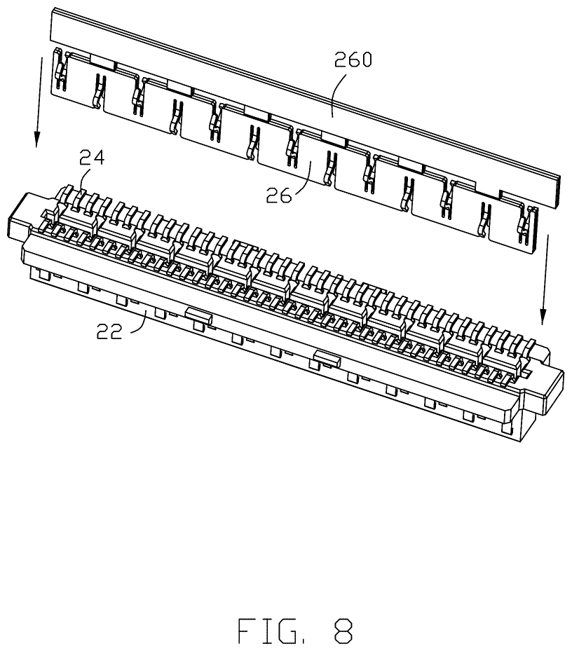

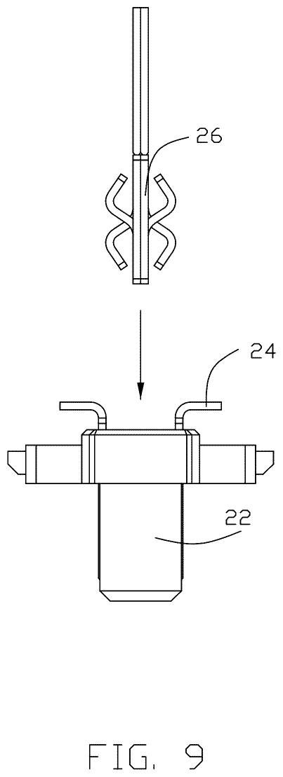

In this embodiment, two rows of the terminals 24 are provided to be disposed in the insulating housing 22 and exposed upon opposite side faces of the tongue 222. Two grounding bars 26 are attached in a back to back form, the beams 262, 263 are attached to corresponding the grounding terminals 244. The beams 262 of a downward type extend downwards each with a lower arc, the beams 263 of an upward type extend upwards each with an upper arc, the upper arcs are located higher than the lower arcs. The grounding terminals 244 of the two rows of terminals 24 are located aligned with each other in a transverse direction perpendicular to a longitudinal direction along which the row of terminals 24 is arranged, so the beams of one grounding bar are opposite to corresponding beams of another grounding bar in the transverse direction. As shown in FIGS. 8-10, the two grounding bars 26 connected with strips 260 are attached together and then inserted in to the cavity 224, the beams 262, 263 elastically attach corresponding grounding terminals 244. Combination with FIG. 5, the row of terminals 24 are retained in an insulator by a first injection process, and then an insulating material are injected around the terminals with the cavity 224 by a second injection process. And then the two grounding bars are inserted in the cavity 224. Last, the strip is cut off.

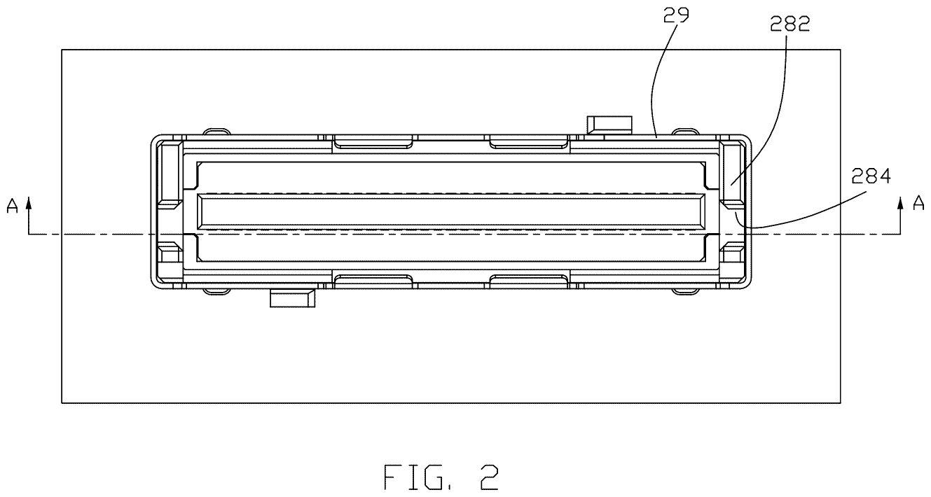

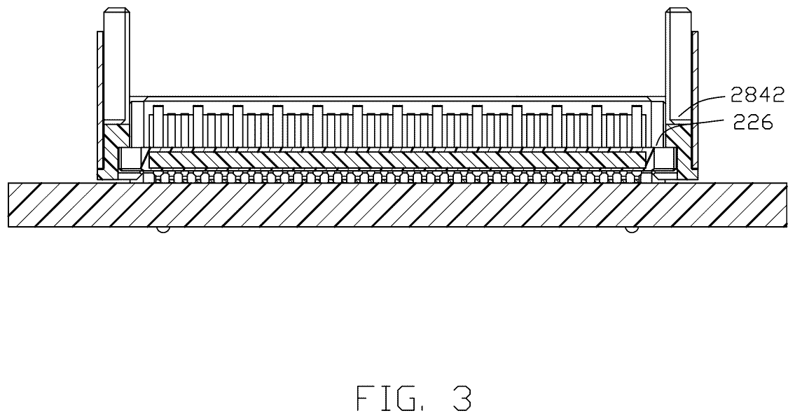

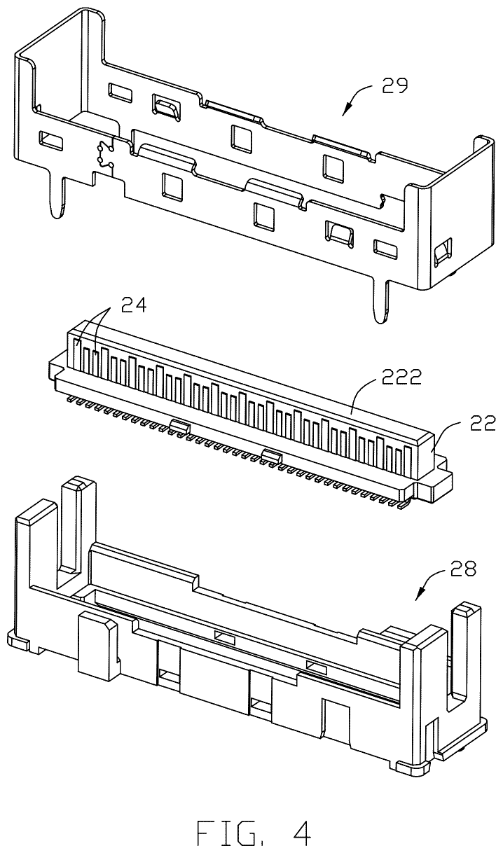

FIGS. 2-3 feature an outline of the receptacle connector 20. In conjunction with FIG. 4, the shroud 28 is generally elongate and may include a pair of end walls 282 and respective notches 284 on the pair of end walls 282. The two notches 284 align with each other along the longitudinal direction while being offsetting from the tongue 222 in the transverse direction. A bottom interior face 2842 of the notch 284 is leveled higher than an interior face 226 of the tongue 222. The pair of end walls 282 protrudes upward beyond the shell 29.

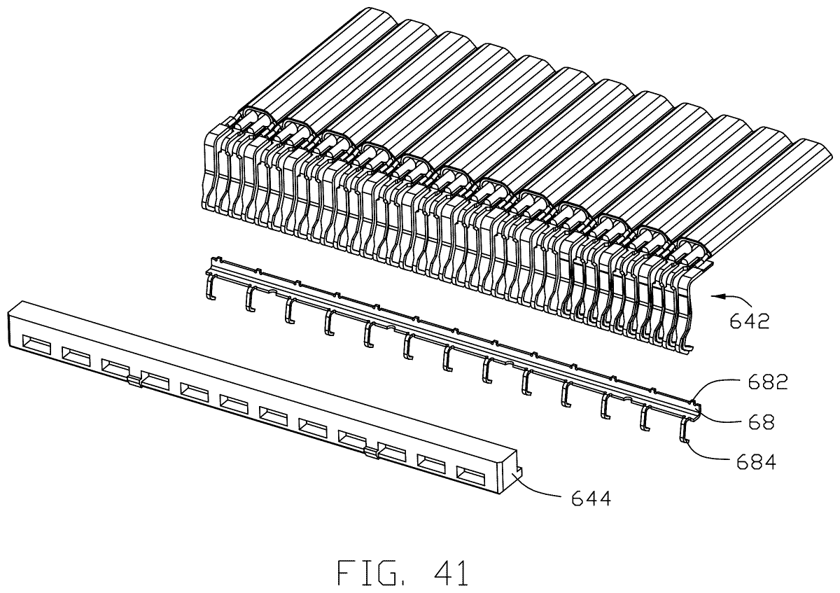

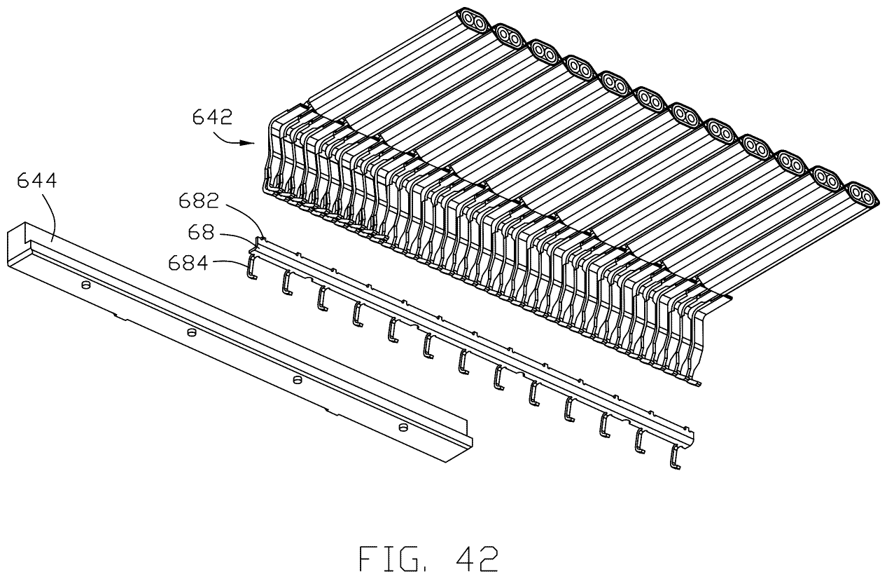

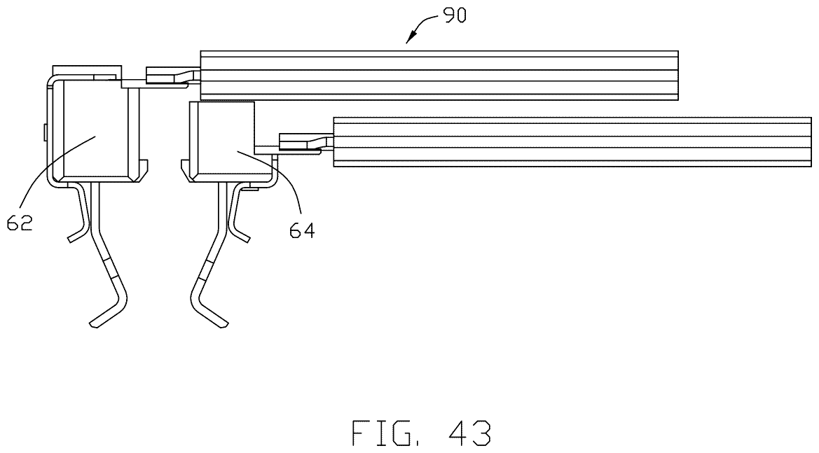

FIGS. 11-30 illustrate an electrical connector assembly 100 includes a varied receptacle connector 20A and a plug connector 50. Referring to the FIGS. 18-23, the varied receptacle connector 20A is similar to the electrical connector 20 with a varied grounding bar 26A. The ground bar 26A has a plurality of first/grounding beams 264 and a plurality of second/engaging beams 266. In this embodiment, each of the first beams 264 includes upward beams 2641 and downward beams 2642 aligned with corresponding upward beams 2641, so that each grounding terminal 244 are attached with two points of the beams 264. The second beam 266 may make an electrical connection to the ground lead-frame 14′ as best shown in FIGS. 12-13. The second beams 266 extend upwards beyond the first beams 264, and beyond a top/mating face 2221 of the tongue 222, the second beam 266 has an arc portion 2661 protruding the mating face 2221 to engage with a grounding plane defined on the plug connector 10 which will be described hereinafter.

Referring to the FIGS. 24-25, the plug connector 50 including a plug contact assembly 60 with a plurality of cable wires 90 terminated thereto. The plug connector 50 may further include an upper cover 72 and a lower cover 74 cooperating to contain the contact assembly 60 and a latch 76. The contact assembly 60 may include a front contact unit 62 and a rear contact unit 64. Other suitable insulator may be further employed to retain the front and rear contact units 62 and 64. Each of the contact units includes a row of contact and a grounding lead frame with a plurality of grounding contacts, and an insulator 16 united the row of contact and the grounding lead frame together.

Firstly referring to FIGS. 31-43, a varied plug contact assembly 60B is illustrated, which is similar to the plug contact assembly 60. The varied plug contact assembly 60B includes a row of contacts 12, a ground lead-frame 14, an insulator (such as insulator 16 seen in FIGS. 25-26) retaining the row of contacts 12 and the ground lead-frame 14, and a plurality of cable wires 900 terminating to the row of contacts 12 and the ground lead-frame 14. The ground lead-frame 14 has a plurality of ground contacts 142 interposed among and aligned with the row of contacts 12. The terminating portions 121 of the row of contacts 12 may be suitably thinned relative to remaining portions as clearly seen in FIG. 43 for impedance matching consideration.

The ground lead-frame 14 is unitary and has a plurality of first/joining bars 144 located at one side of the row of contacts 12 and a plurality of second/engaging bars 146 located at an opposite side of the row of contacts 12. Each of the plurality of first bars 144 and the plurality of second bars 146 is connected between two adjacent ground contacts 142. A pair of the contacts 12 goes across the first bar 144. The plug contact assembly 60B is clearly shown in this embodiment. The first bars 144 are joined the grounding contact 142 together to be the unitary grounding lead frame 14. The second bars 146 are joined the grounding contacts 142 together, and the second bar 146 extend to and is adapted for make a connection with the grounding bar of the receptacle connector 20A.

Back to FIGS. 26-30, the grounding lead frame 14′ is similar the grounding lead frame 14 of the varied plug contact assembly 60B. Specifically, the ground lead-frame 14′ may include one or more engaging ends 1422 protruding outwards the insulator 16. A ground plate 18 may include one or more slits 182 each receiving and being retained with a corresponding engaging end 1422. As shown, the arc portions 2661 of the second beams 266 touch the grounding plate 18 to get an electric connector between the grounding lead frame 14′ and the grounding bars 26A when the plug connector is inserted into the receptacle connector 20. That means, the grounding lead-frame is electrically connected with the grounding bars 26 via the grounding plate, the engaging ends 1422 is functioned as the second beams, the first beams 148 are connected with every adjacent grounding contacts 142 As shown in FIGS. 12 and 13 and 15, the grounding plate 18 exposes upon an inner bottom 501 of a mating cavity 501 of the plug connector 10 to make an engagement with the second beams 266. The lower cover 74 defines an insulating base 502 which defines said mating cavity 501. Back to FIG. 33, the second beams 142 extend into the mating cavity 501 and the exposes upon the inner bottom of the mating cavity 501 of the plug connector when the two connectors are mated together, the second beams 266 also are engaged with the second bars 146 of the receptacle connector. FIGS. 28-29 further show that each of the row of contacts 12 has a concave end face 122 and each of the plurality of cable wires 90 extends across and is terminated to the concave end face 122.

In summary, an electrical connector assembly of the invention comprises a plug connector and a receptacle connector. The receptacle connector includes a ground bar that is stamped and formed of copper. When two ground bars are assembled back-to-back, the touch fingers thereof represent a spider-shape. The receptacle connector also includes a pair of contact arrays each consisting of ground contacts and signal contacts that is first shot insert molded as an insert molded lead-frame assembly (IMLA). Two IMLAs are then addressed to a mold for second shot molding of main strip. Underside of the main strip has channels cored out for spider-shape ground bar touch fingers to make contact with ground contacts at assembly. The spider-shape ground bars make intimate contact with the ground contacts, thus creating a common ground with touch points at staggered locations. The plug connector includes integrated ground contacts blanked in one continuous lead-frame with common ground bar to form a ground lead-frame. The ground lead-frame has upper and lower ground bars and coined areas. The coined area at cable termination will raise impedance prior to hot melt glue; after applying the hot melt glue for strength, the impedance will fall into the desired range. Another wire termination design is that wire is attached onto a half-moon structure at the tip of lead frame and drain wires are soldered on an upper level compared to signal pairs for building a common GND for signal integrity (SI) purpose. A further common ground (GND) bar design is that on the bottom there is an elastic beam for common GND bar to only touch the GND lead frame while on the top the common GND bar is laser welded onto GND lead frame. This design can achieve different touching positions by adjusting length of the elastic beam, even on moving area of the lead frame, which will benefit SI performance. Also, for better impedance control design at termination, open air pocket under the wire termination area may be provided to increase the impedance at this area and may be made thinner. The main housing may have features to better locating the common GND bar elastic beam for tolerance control.

FIGS. 37-43 show a varied plug contact assembly 60C with a plurality of cable wires 90 terminated thereto. The plug connector may further include an upper cover 72 and a lower cover 74 (such as those shown in FIGS. 24 and 28) cooperating to contain the plug contact assembly 60 and a latch 76. The contact assembly 60C may include a front contact unit 62 and a rear contact unit 64. Other suitable insulator may be further employed to retain the front and rear contact units 62 and 64. The front contact unit 62 may include a row of contacts 622, an insulator 624 retaining the row of contacts 622, and a ground bar 66. The rear contact unit 64 may include a row of contacts 642, an insulator 644 retaining the row of contacts 642, and a ground bar 68. Each of the front and rear ground bars 66 and 68 may be suitably secured to securing features disposed on the associated insulator 624 or 644. The cable wire 90 may be twin-ax raw cable wires directly attached to the contacts 622 or 642 in a well-known manner. The front ground bar 66 may include a plurality of first fingers 662 each engaging a securing portion of a corresponding ground contact 622 and a plurality of second fingers 664 each resiliently engaging a contacting portion of the corresponding ground contact 622. The rear ground bar 68 may include a plurality of first fingers 682 each engaging a securing portion of a corresponding ground contact 642 and a plurality of second fingers 684 each resiliently engaging a contacting portion of the corresponding ground contact 642. The second fingers 664 and 684 are designed as elastic beams which may be easily adjusted, even on moving portions of the ground contacts 622 and 642, as to lengths in order to improve SI performance.

The above-mentioned embodiments are only preferred embodiments of the present invention, and should not limit the scope of the present invention, any simple equivalent changes and modifications made according to the claims of the present invention and the contents of the description should still belong to the present invention.

1. An electrical connector assembly comprising:
a plug connector comprising:
a row of contacts, a ground lead-frame, and an insulator retaining the row of contacts and the ground lead-frame, the ground lead-frame having a plurality of ground contacts interposed among and aligned with the row of contacts; and
a plurality of cable wires terminating to the row of contacts and the ground contacts of the ground lead-frame; and
a receptacle connector comprising:
an insulating housing having a tongue;
a row of terminals secured to the insulating housing and exposing to the tongue, the row of terminals comprising a plurality of signal terminals and a plurality of ground terminals; and
a ground bar disposed in the insulating housing and electrically connect with the plurality of ground terminals;
wherein the ground bar has at least one beam for making an electrical connection to the ground lead-frame when the plug connected is inserted in the receptacle connector.

2. The electrical connector assembly as claimed in claim 1, wherein the grounding lead-frame has a plurality of bars connected with every adjacent two grounding contacts for contacting the grounding bar.

3. The electrical connector assembly as claimed in claim 1, wherein the plug connector comprises a ground plate engaging the ground lead-frame, and the ground plate is for contacting the at least one beam of the grounding bar of the receptacle connector.

4. The electrical connector assembly as claimed in claim 1, wherein the at least one beam of the grounding bar protrudes upward beyond a mating face of the tongue.

5. A plug connector comprising:
an insulating base having a mating cavity with two opposite inner face and an inner bottom;
a row of contacts, a ground lead-frame, and an insulator retaining the row of contacts and the ground lead-frame, the ground lead-frame having a plurality of ground contacts interposed among and aligned with the row of contacts; and
a plurality of cable wires terminating to the row of contacts and the ground contacts of the ground lead-frame;
wherein the row of contacts and the plurality of grounding contacts are arrange along the inner side, the ground lead-frame has a plurality of engaging bars each connected between two adjacent ground contacts, and the engaging bars expose upon the inner bottom of the mating cavity.

6. The plug connector as claimed in claim 5, wherein each of the row of contacts has a concave end face and each of the plurality of cable wires extends across and is terminated to the concave end face.

7. The plug connector as claimed in claim 5, wherein the connecting bars bend from the grounding lead-frame and disposed parallel to the inner bottom.

8. The plug connector as claimed in claim 5, wherein the engaging bars bend from the grounding lead-frame and are attached to a grounding plate disposed on the inner bottom of the mating cavity.

9. The plug connector as claimed in claim 5, wherein the grounding lead-frame has a plurality of joining bars each connected between every two adjacent ground contacts, every two contacts go across the joining bar, the joining bars and the engaging bars are located on opposite sides of the row of the contacts.

10. A receptacle connector comprising:
an insulating housing having a tongue;
a row of terminals secured to the insulating housing and exposing to a side face of the tongue, the row of terminals comprising a plurality of signal terminals and a plurality of ground terminals; and
a ground bar disposed in insulating housing and connected with the plurality of ground terminals;
wherein the ground bar has at least one engaging beam exposing upon a mating face of the tongue intersected with the side face.

11. The receptacle connector as claimed in claim 10, wherein the at least one engaging beam has an arc portion extending beyond the mating face.

12. The receptacle connector as claimed in claim 10, wherein the at least one connecting beam has a plurality of grounding beams contacting the plurality of grounding terminals respectively.

13. The receptacle connector as claimed in claim 10, wherein the grounding bar has a plurality of grounding beams punched from the grounding bar, and two engaging beams extend from a top edge of the grounding plate.

14. The receptacle connector as claimed in claim 10, wherein another row of terminals is secured to the insulating housing and expose to another side face of the tongue, and an another grounding bar is attached to the grounding bar in a back to back form.
